(19) United States
(12) Patent Application Publication
(10) Pub. No.: US 2022/0095041 A1
(43) Pub. Date: Mar. 24, 2022

(54) EARPHONE

(71) Applicant: Merry Electronics(Shenzhen) Co., Ltd., ShenZhen (CN)

(72) Inventor: Hsin-Hung Yu, Taichung (TW)

(73) Assignee: Merry Electronics(Shenzhen) Co., Ltd., ShenZhen (CN)

(21) Appl. No.: 17/093,574

(22) Filed: Nov. 9, 2020

(30) Foreign Application Priority Data
Sep. 24, 2020 (TW) 109212638

(51) Int. Cl. H04R 1/28; H04R 1/10

(52) U.S. Cl. CPC H04R 1/2826; H04R 2460/11; H04R 1/1075; H04R 1/1016

(57) ABSTRACT

An earphone includes a housing, a speaker holder, an inner cover, and a bass tube. The housing includes a front cover and a back cover. An accommodating space is formed between the front cover and the back cover, and a speaker is disposed in the accommodating space. The speaker holder is disposed in the accommodating space of the housing, and the speaker holder is disposed between the front cover and the speaker. The inner cover is disposed in the accommodating space of the housing and between the back cover and the speaker, and a back cavity is formed by an inner surface of the inner cover and the speaker together. The bass tube is formed on the inner cover.

### CROSS-REFERENCE TO RELATED APPLICATION

This application claims the priority benefit of Taiwan application serial no. 109212638, filed on Sep. 24, 2020. The entirety of the above-mentioned patent application is hereby incorporated by reference herein and made a part of this specification.

### BACKGROUND

### Technical Field

The disclosure relates to an earphone, and particularly relates to an earphone with a bass tube.

### Description of Related Art

As technology advances, consumers have higher expectations for the sound quality of earphones. Therefore, how to provide good sound quality is an issue that needs to be addressed in this field.

### SUMMARY

The disclosure provides an earphone with a bass tube, which provides good bass quality.

An earphone according to the disclosure includes a housing, a speaker holder, an inner cover, and a bass tube. The housing includes a front cover and a back cover. An accommodating space is formed between the front cover and the back cover, and a speaker is disposed in the accommodating space. The speaker holder is disposed in the accommodating space of the housing, and the speaker holder is disposed between the front cover and the speaker. The inner cover is disposed in the accommodating space of the housing, and the inner cover is located between the back cover and the speaker. An inner surface of the inner cover and the speaker together form a back cavity. The bass tube is formed on the inner cover.

In an embodiment of the disclosure, the earphone further includes a baffle disposed in the inner cover and located between the inner cover and the speaker. A part of the bass tube is formed between the baffle and the inner cover.

In an embodiment of the disclosure, the inner cover includes a first groove recessed in the inner surface, a second groove located in the first groove, and a first through hole connected to the second groove. The second groove is recessed in a groove bottom surface of the first groove, and the baffle is located in the first groove and abuts on the groove bottom surface.

In an embodiment of the disclosure, the baffle includes a second through hole, and the first through hole is located at one end of the second groove, and the second through hole corresponds to the other end of the second groove.

In an embodiment of the disclosure, the back cover includes a first through passage, and the bass tube is formed by the second through hole of the baffle, the second groove of the inner cover, the first through hole, and the first through passage of the back cover.

In an embodiment of the disclosure, the earphone further includes a flexible member disposed between the inner cover and the back cover and including an opening. The opening corresponds to the first through hole of the inner cover and the first through passage of the back cover.

In an embodiment of the disclosure, the inner cover further includes a glue groove recessed in the groove bottom surface of the first groove, and the baffle covers the glue groove.

In an embodiment of the disclosure, the baffle includes a baffle surface facing the speaker, and the baffle surface is lower than or flush with the inner surface of the inner cover.

In an embodiment of the disclosure, the speaker holder includes a hollow accommodating cavity penetrating through the speaker holder, and the speaker is located in the hollow accommodating cavity, and a sound output surface of the speaker is exposed outside the speaker holder and is covered by the front cover.

In an embodiment of the disclosure, an outer contour of the speaker holder matches an inner contour of the front cover, and the speaker holder is fastened in the front cover.

In an embodiment of the disclosure, the inner cover includes a sound release hole penetrating through the inner cover, and the back cover includes a second through passage corresponding to the sound release hole, and a sound release tube is formed by the sound release hole of the inner cover and the second through passage of the back cover.

In an embodiment of the disclosure, the bass tube is formed on the inner surface of the inner cover.

Based on the above, the earphone of the disclosure includes the inner cover disposed in the accommodating space of the housing and located between the back cover and the speaker. The inner surface of the inner cover and the speaker together form the back cavity, and the bass tube is formed on the inner cover. Since the earphone of the disclosure has the bass tube formed on the inner cover, the earphone provides good bass performance.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic view of an earphone according to an embodiment of the disclosure.

FIG. 2 is an exploded schematic view of the earphone of FIG. 1.

FIG. 3 is a schematic view of FIG. 2 from another perspective.

FIG. 4 is a schematic cross-sectional view of the earphone of FIG. 1 along a second groove.

FIG. 5 is a schematic view of the earphone of FIG. 1 before a baffle is assembled to an inner cover.

FIG. 6 is a schematic cross-sectional view of the earphone of FIG. 1 when the baffle is assembled to the inner cover.

### DETAILED DESCRIPTION OF DISCLOSED EMBODIMENTS

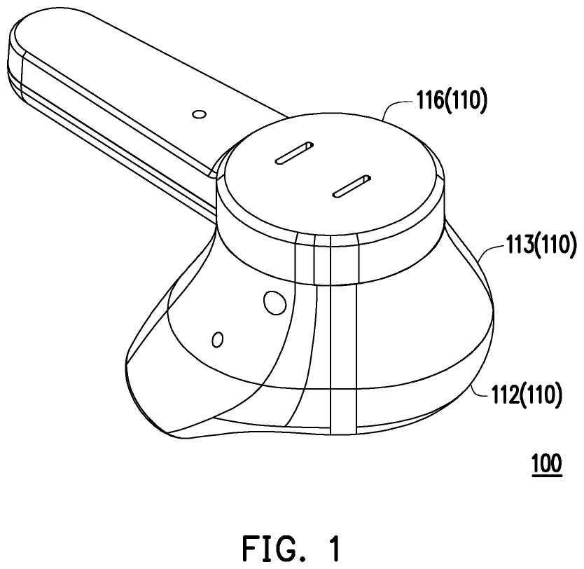

FIG. 1 is a schematic view of an earphone according to an embodiment of the disclosure. Referring to FIG. 1, in the present embodiment, the earphone 100 is an in-ear earphone, for example. The earphone 100 provides good bass quality. Details will be described hereinafter.

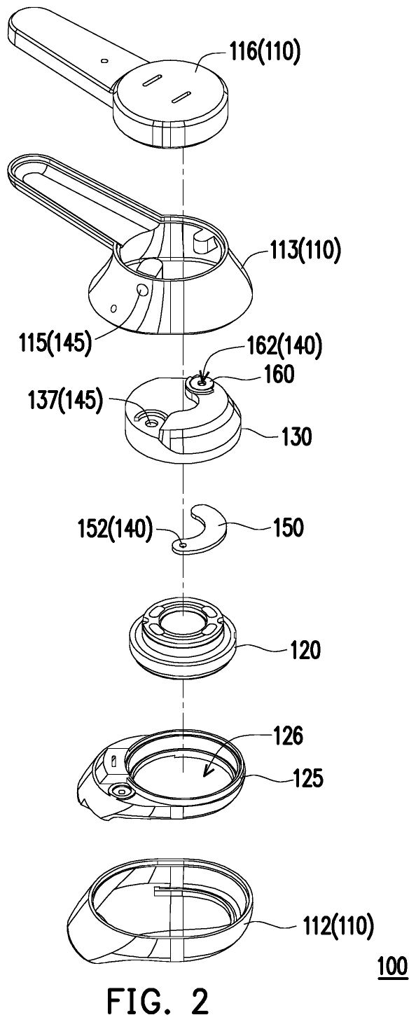

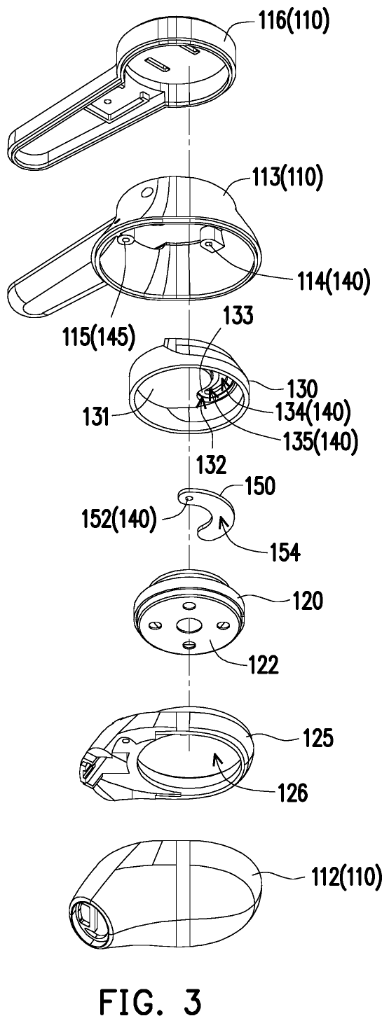

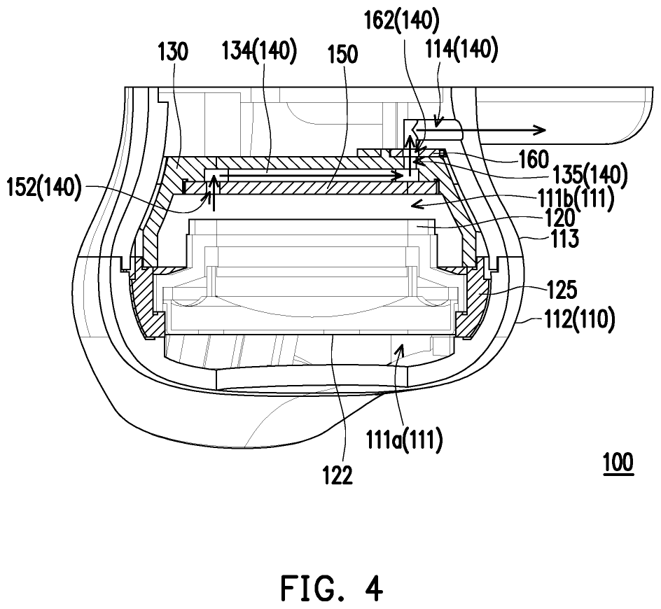

FIG. 2 is an exploded schematic view of the earphone of FIG. 1. FIG. 3 is a schematic view of FIG. 2 from another perspective. FIG. 4 is a schematic cross-sectional view of the earphone of FIG. 1 along a second groove. Referring to FIG. 2 to FIG. 4, in the present embodiment, the earphone 100 includes a housing 110, a speaker 120, a speaker holder 125, an inner cover 130, and a bass tube 140. The housing 110 includes a front cover 112, a back cover 113, and a back casing 116. The front cover 112 is assembled to the back cover 113, and the back casing 116 covers on the back cover 113.

As shown in FIG. 4, an accommodating space 111 is formed between the front cover 112 and the back cover 113. The speaker holder 125 is disposed in the accommodating space 111 of the housing 110, and the speaker 120 is disposed on the speaker holder 125 and is located in the accommodating space 111 of the housing 110. The speaker holder 125 is between the front cover 112 and the speaker 120. In the present embodiment, the outer contour of the speaker 120 matches the inner contour of the speaker holder 125, and the outer contour of the speaker holder 125 matches the inner contour of the front cover 112. The speaker 120 is fastened in the speaker holder 125, and the speaker holder 125 is fastened in the front cover 112.

In the conventional structure, the speaker is directly attached to the front housing. However, as the earphone has more functions, the design of the inner surface of the front housing may become more complicated. For example, the inner surface of the front housing may have a structure for disposing a microphone circuit board and thus needs to have a special shape while the outer surface of the front housing needs to have a smooth appearance. Such a structure may impose difficulty on injection molding. Therefore, in the present embodiment, the speaker holder 125 is disposed between the speaker 120 and the front cover 112, and a more complicated structure can be disposed on the speaker holder 125, which facilitates the formation of a special shape without affecting the appearance of the front cover 112.

In addition, the speaker holder 125 has a hollow accommodating cavity 126 penetrating therethrough (FIG. 2), and the speaker 120 is located in the hollow accommodating cavity 126. Since the speaker 120 is located in the hollow accommodating cavity 126 of the speaker holder 125, the speaker holder 125 does not cover the speaker 120 in the thickness direction, which allows the overall thickness of the earphone 100 to be reduced. In addition, a sound output surface 122 of the speaker 120 is directly exposed outside the speaker holder 125 and is covered by the front cover 112, which serves as a side sound output structure.

Furthermore, the inner cover 130 is disposed in the accommodating space 111 of the housing 110 and between the back cover 113 and the speaker 120. In the present embodiment, the diaphragm of the speaker 120 can be used as the boundary line for distinguishing a front cavity 111a from a back cavity 111b. The back cavity 111b is located between an inner surface 131 (FIG. 3) of the inner cover 130 and the diaphragm of the speaker 120.

It is worth mentioning that in the present embodiment, the bass tube 140 is formed on the inner surface 131 of the inner cover 130. When assembled, the speaker 120 is disposed in the speaker holder 125, and the inner cover 130 is fixed on the speaker holder 125. Then, the assembler may perform an airtight test on the semi-finished product composed of the inner cover 130, the speaker 120, and the speaker holder 125 (that is, most areas of the bass tube 140), and assemble the front cover 112 and the back cover 113 after checking the airtightness. In this way, the earphone 100 does not need to be fully assembled to test the airtightness, which eliminates the need to completely disassemble the earphone if it is not airtight.

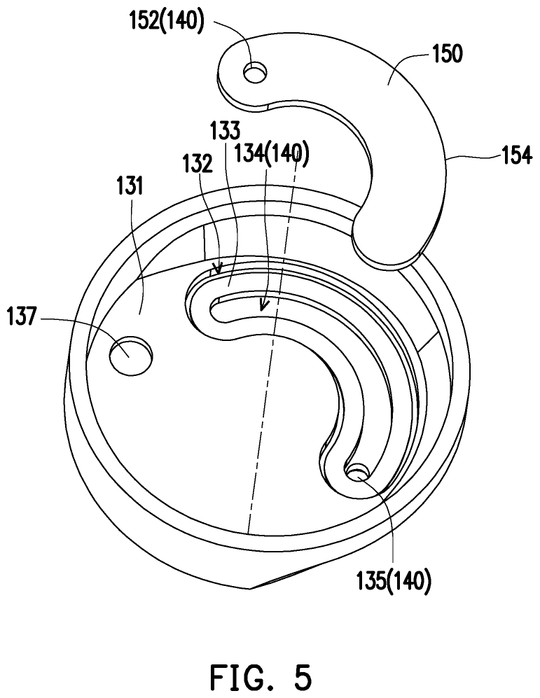

FIG. 5 is a schematic view of the earphone of FIG. 1 before a baffle is assembled to the inner cover. Referring to FIG. 5, the inner cover 130 has a first groove 132 recessed in the inner surface 131, a second groove 134 located in the first groove 132, and a first through hole connected to the second groove 134. The second groove 134 is recessed in a groove bottom surface 133 of the first groove 132.

The earphone 100 further includes a baffle 150, which is disposed in the inner cover 130. The baffle 150 is located between the inner cover 130 and the speaker 120 (FIG. 4). The baffle 150 is located in the first groove 132 and abuts on the groove bottom surface 133. The baffle 150 has a second through hole 152. The first through hole 135 is located at one end of the second groove 134, and the second through hole 152 corresponds to the other end of the second groove 134.

In addition, as shown in FIG. 3 and FIG. 4, the back cover 113 has a first through passage 114. As shown in FIG. 2 and FIG. 4, the earphone 100 further includes a flexible member 160 disposed between the inner cover 130 and the back cover 113. The flexible member 160 is, for example, foam, but not limited thereto. The flexible member 160 has an opening 162 corresponding to the first through hole 135 of the inner cover 130 and the first through passage 114 of the back cover 113.

It can be clearly seen from FIG. 4 that in the present embodiment, the bass tube 140 is formed by the second through hole 152 of the baffle 150, the second groove 134 of the inner cover 130, the first through hole 135, the opening 162 of the flexible member 160, and the first through passage 114 of the back cover 113, and enables the earphone 100 to provide good bass quality. In addition, since the bass tube 140 is mainly located inside the housing 110, the bass tube 140 is well protected.

Since the semi-finished product composed of the inner cover 130, the speaker 120, and the speaker holder 125 is assembled first, and the flexible member 160 and the back cover 113 are assembled after the airtight test to complete the assembly of the bass tube 140, in the second stage of assembly, only the positions of the flexible member 160 and the back cover 113 need to be checked. As a result, the number of components that need to be accurately positioned is small, and the assembly is relatively simple. Since the number of components is small, the accumulated tolerance can be reduced.

In addition, reverting to FIG. 2, in the present embodiment, the inner cover 130 has a sound release hole 137 penetrating therethrough. The back cover 113 has a second through passage 115 corresponding to the sound release hole 137, and a sound release tube 145 is formed by the sound release hole 137 of the inner cover 130 and the second through passage 115 of the back cover 113. The sound release tube 145 can enhance the sound performance of the earphone 100.

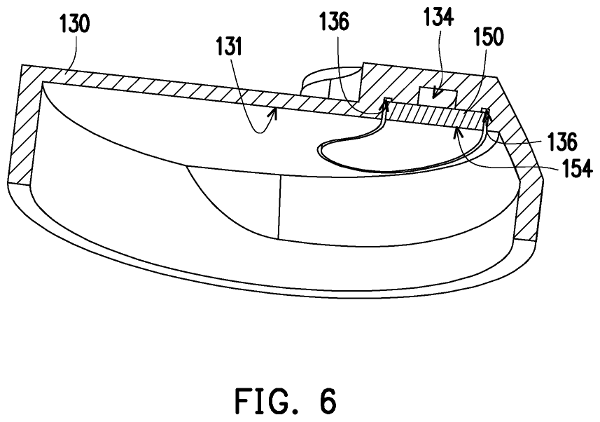

FIG. 6 is a schematic cross-sectional view of the earphone of FIG. 1 when the baffle is assembled to the inner cover. Referring to FIG. 6, in the present embodiment, the baffle 150 has a baffle surface 154 facing the speaker 120, and the baffle surface 154 is flush with the inner surface 131 of the inner cover 130. In other embodiments, the baffle surface 154 may be lower than the inner surface 131 of the inner cover 130.

In other words, the baffle surface 154 does not protrude from the inner surface 131 of the inner cover 130. As can be seen from FIG. 4, since there is a certain distance between the inner surface 131 of the inner cover 130 and the speaker 120 for disposing the wires (not shown) of the speaker 120, in the present embodiment, the design that the baffle surface 154 does not protrude from the inner surface 131 of the inner cover 130 prevents the baffle 150 from affecting the space for disposing the wires of the speaker 120.

In addition, since the bass tube 140 is designed inside the earphone 100, the sealing between the components of the bass tube 140 is very important in order to avoid affecting the bass effect. In the present embodiment, the inner cover 130 further has a glue groove 136 recessed in the groove bottom surface 133 of the first groove 132. A glue (not shown) is disposed in the glue groove 136, and the baffle 150 covers the glue groove 136 to be fixed to the inner cover 130.

The glue groove 136 may be designed along the edge of the entire baffle 150. Such a design can increase the bonding area between the baffle 150 and the inner cover 130. The glue may have a strong bonding force and low shrinkage. In other embodiments, the baffle 150 and the inner cover 130 may also be fixed by adhesive.

In summary, the earphone of the disclosure includes the inner cover disposed in the accommodating space of the housing and between the back cover and the speaker. The inner surface of the inner cover and the speaker together form the back cavity, and the bass tube is formed on the inner cover. Since the earphone of the disclosure has the bass tube formed on the inner cover, the earphone can provide good bass performance. In addition, since the speaker is disposed in the speaker holder, and the inner cover is fixed on the speaker holder, when assembled, the semi-finished product composed of the inner cover, the speaker, and the speaker holder is tested for airtightness first to ensure that the front cover and the back cover are assembled in the state where most areas of the bass tube are airtight, which eliminates the need to completely disassemble the earphone if it is not airtight.

1. An earphone, comprising:
a housing comprising a front cover and a back cover, wherein an accommodating space is formed between the front cover and the back cover, and a speaker is disposed in the accommodating space;
a speaker holder disposed in the accommodating space of the housing and located between the front cover and the speaker;
an inner cover disposed in the accommodating space of the housing and located between the back cover and the speaker, wherein an inner surface of the inner cover and the speaker together form a back cavity; and
a bass tube formed on the inner cover, wherein the speaker is located in the speaker holder.

2. The earphone according to claim 1, further comprising:
a baffle disposed in the inner cover and located between the inner cover and the speaker, wherein a part of the bass tube is formed between the baffle and the inner cover.

3. The earphone according to claim 2, wherein the inner cover comprises a first groove recessed in the inner surface, a second groove located in the first groove, and a first through hole connected to the second groove, wherein the second groove is recessed in a groove bottom surface of the first groove, and the baffle is located in the first groove and abuts on the groove bottom surface.

4. The earphone according to claim 3, wherein the baffle comprises a second through hole, and the first through hole is located at one end of the second groove, and the second through hole corresponds to the other end of the second groove.

5. The earphone according to claim 4, wherein the back cover comprises a first through passage, and the bass tube is formed by the second through hole of the baffle, the second groove of the inner cover, the first through hole, and the first through passage of the back cover.

6. The earphone according to claim 5, further comprising:
a flexible member disposed between the inner cover and the back cover and comprising an opening, wherein the opening corresponds to the first through hole of the inner cover and the first through passage of the back cover.

7. The earphone according to claim 3, wherein the inner cover further comprises a glue groove recessed in the groove bottom surface of the first groove, and the baffle covers the glue groove.

8. The earphone according to claim 3, wherein the baffle comprises a baffle surface facing the speaker, and the baffle surface is lower than or flush with the inner surface of the inner cover.

9. The earphone according to claim 1, wherein the speaker holder comprises a hollow accommodating cavity penetrating through the speaker holder, and the speaker is located in the hollow accommodating cavity, and a sound output surface of the speaker is exposed outside the speaker holder and is covered by the front cover.

10. The earphone according to claim 1, wherein an outer contour of the speaker holder matches an inner contour of the front cover, and the speaker holder is fastened in the front cover.

11. The earphone according to claim 1, wherein the inner cover comprises a sound release hole penetrating through the inner cover, and the back cover comprises a second through passage corresponding to the sound release hole, and a sound release tube is formed by the sound release hole of the inner cover and the second through passage of the back cover.

12. The earphone according to claim 1, wherein the bass tube is formed on the inner surface of the inner cover.
